(19) United States
(12) Patent Application Publication
(10) Pub. No.: US 2013/0275814 A1
(43) Pub. Date: Oct. 17, 2013

(54) ADAPTIVE SYSTEM MONITORING

(71) Applicants: Shiva Prasad Nayak, Bangalore (IN); Shridevi Baichwal, Bangalore (IN); Ekantheshwara Basappa, Bangalore (IN); Ramya Sharma, Bangalore (IN); Savitha K. Sridhar, Bangalore (IN)

(72) Inventors: Shiva Prasad Nayak, Bangalore (IN); Shridevi Baichwal, Bangalore (IN); Ekantheshwara Basappa, Bangalore (IN); Ramya Sharma, Bangalore (IN); Savitha K. Sridhar, Bangalore (IN)

(21) Appl. No.: 13/445,089

(22) Filed: Apr. 12, 2012

(51) Int. Cl. G06F 11/30

(52) U.S. Cl. 714/47.2; 714/47.1; 714/E11.179

(57) ABSTRACT

Various embodiments of systems and methods for monitoring a system are described herein. A request is received from a user to generate a system watch for monitoring a system. The request may include a primary system monitoring parameter to be included in the system watch. One or more system monitoring parameters correlated to the primary system watch are identified from a system monitoring parameter database. The system watch is generated based on the primary system monitoring parameter and at least one secondary system monitoring parameter from the identified one or more system monitoring parameters. In one aspect, the system monitoring parameter database is built based on system watch related input received for a plurality of system watches.

### FIELD

Embodiments generally relate to computer systems, and more particularly to methods and systems for monitoring a system.

### BACKGROUND

Monitoring tools such as SAP® BusinessObjects Monitoring Tool may be used to monitor systems, such as data servers, storage systems, etc. A user using these monitoring tools may want to create a custom system watch for monitoring the system. For creating the custom system watch, the user needs to choose a set of system monitoring parameters, from a list of system monitoring parameters, based on which the system watch monitors the system. However, system monitoring parameters list may be very large and choosing the right set of system monitoring parameters, for creating the custom system watch, is believed to be difficult.

### BRIEF DESCRIPTION OF THE DRAWINGS

The claims set forth the embodiments of the invention with particularity. The invention is illustrated by way of example and not by way of limitation in the figures of the accompanying drawings in which like references indicate similar elements. The embodiments of the invention, together with its advantages, may be best understood from the following detailed description taken in conjunction with the accompanying drawings.

FIG. 1 is a flow diagram illustrating a method for monitoring a system, according to an embodiment.

FIGS. 2A-2B is a flow diagram illustrating a method for building a system monitoring parameter database, according to an embodiment.

FIGS. 3A-3B is a flow diagram illustrating a method for monitoring a system based on the system monitoring parameter database built in FIGS. 2A-2B, according to an embodiment.

FIG. 4 is a block diagram illustrating a system for generating a system watch, according to an embodiment.

FIG. 5 is an exemplary block diagram illustrating system watch related input, according to an embodiment.

FIG. 6 is an exemplary block diagram illustrating system monitoring parameters retrieved from the system watch related input of FIG. 5, according to an embodiment.

FIGS. 7A-7C are exemplary block diagrams illustrating filtering of the system monitoring parameters of FIG. 6, according to an embodiment.

FIG. 8 is an exemplary block diagram illustrating a filtered set of system monitoring parameters obtained after the filtering operations of FIGS. 7A-C, according to an embodiment.

FIG. 9 is an exemplary block diagram illustrating a posterior probability matrix for the filtered set of system monitoring parameters of FIG. 8, according to an embodiment.

FIG. 10 is an exemplary correlation list obtained by applying a genetic algorithm on the posterior probability matrix of FIG. 9, according to an embodiment.

FIG. 11 is an exemplary block diagram illustrating a threshold matrix storing threshold values of the filtered set of system monitoring parameters of FIG. 8, according to an embodiment.

FIG. 12 is an exemplary block diagram illustrating system watch related equations generated based on the correlation list of FIG. 10 and the threshold matrix of FIG. 11, according to an embodiment.

FIG. 13 is an exemplary user interface displaying correlated system monitoring parameters based on a received user request, according to an embodiment.

FIG. 14 is an exemplary block diagram illustrating a system watch generated based on the received user request and the displayed correlated system monitoring parameters of FIG. 13, according to an embodiment.

FIG. 15 is a block diagram illustrating a computing environment in which the techniques described for monitoring a system can be implemented, according to an embodiment.

### DETAILED DESCRIPTION

Embodiments of techniques for adaptive system monitoring are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment”, “this embodiment” and similar phrases, means that a particular feature, structure, or characteristic described in connection with the embodiment is included in at least one embodiment of the present invention. Thus, the appearances of these phrases in various places throughout this specification are not necessarily all referring to the same embodiment. Furthermore, the particular features, structures, or characteristics may be combined in any suitable manner in one or more embodiments.

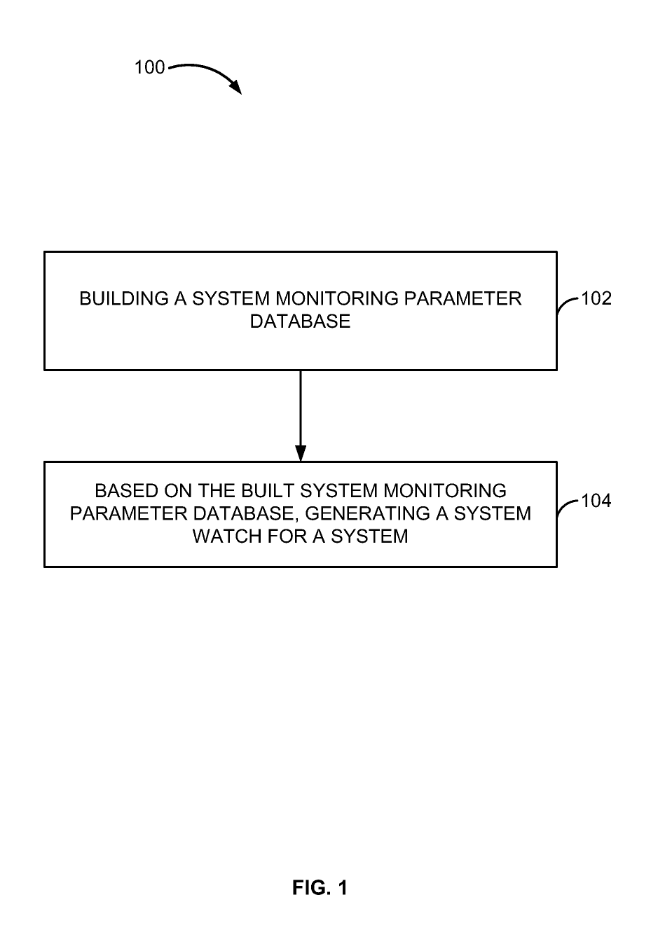

FIG. 1 is a flow diagram 100 illustrating a method for monitoring a system, according to an embodiment. The system may be a software system or a hardware system. For example, the system may be software or a hardware server, or a computer resource like CPU or memory. In one embodiment, a system watch is used to monitor the system. The system watch may include system monitoring parameters, based on which the system watch monitors the system. For example, if the system is a memory, then the system watch may include system monitoring parameters such as free memory, cache hit rate, etc., for monitoring the system.

Initially at block 102 a system monitoring parameter database is built based on system watch related input. The system monitoring parameter database may be built by analyzing a trend of system monitoring parameters received in the system watch related input, and then determining a correlation between the different system monitoring parameters, based on the analysis. The determined correlation between the system monitoring parameters may be stored in the system monitoring parameter database. For example, the trend of the system monitoring parameters in the system watch related input may be analyzed to determine that a system monitoring parameter “disk space” is correlated with a system monitoring parameter “received jobs”. The determined correlation between the system monitoring parameters “disk space” and “received jobs” may be stored in the system monitoring parameter database.

Next at block 104, a system watch is generated based on the system monitoring parameter database built at block 102. In one embodiment, a user selects a primary system monitoring parameter for generating the system watch. Based on the correlation information stored in the system monitoring parameter database, system monitoring parameters correlated to the primary system monitoring parameter are retrieved from the system monitoring parameter database. The system watch is then generated using the primary system monitoring parameter and the system monitoring parameters correlated to the primary system monitoring parameter. In the above example, consider that a primary system monitoring parameter “disk space” is received for generating a system watch. Based on the correlation information stored in the system monitoring parameter database, the system monitoring parameter “received jobs” is identified as correlated to the primary system monitoring parameter “received jobs”. The system watch may then be generated using the primary system monitoring parameter “disk space” and the system monitoring parameter “received jobs” correlated to the primary system monitoring parameter.

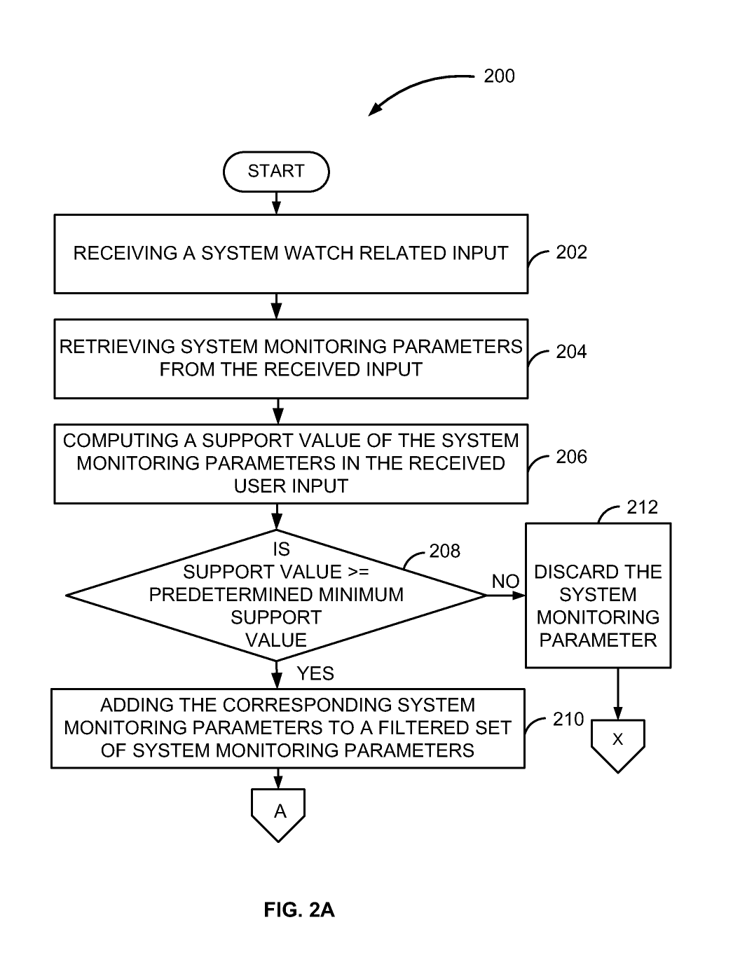

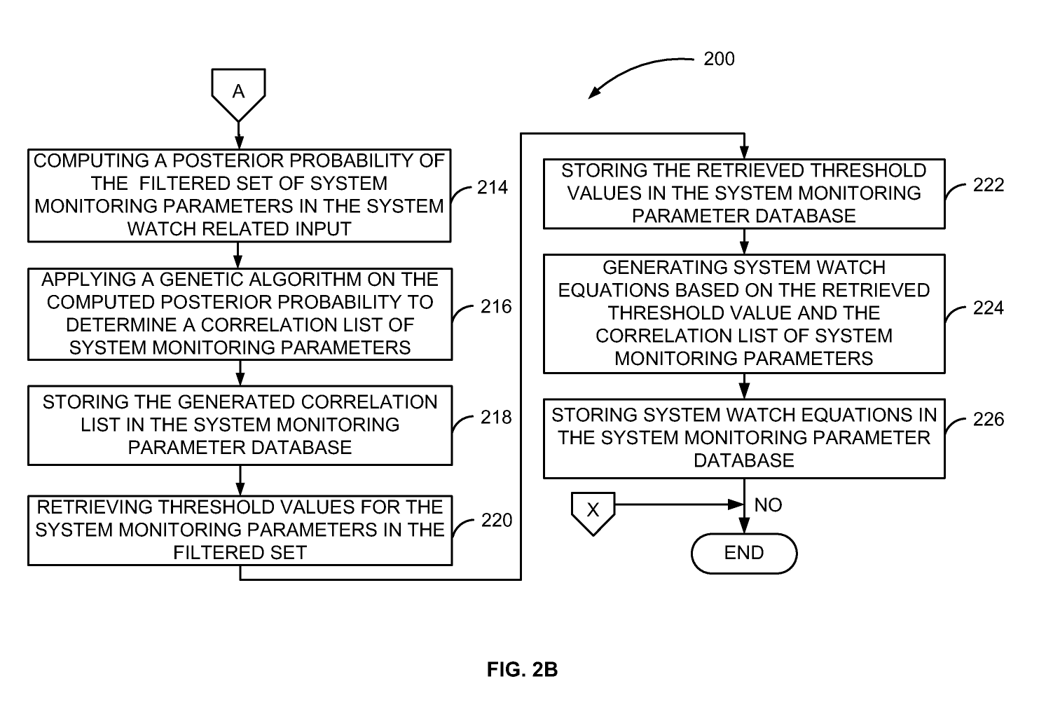

FIGS. 2A-2B is a flow diagram 200 illustrating a method for building a system monitoring parameter database, according to an embodiment. Initially, at block 202, system watch related inputs, related to several system watches, may be received. The system watch related inputs may include default system watches defined for monitoring a particular system. For example, a default system watch may be defined for monitoring a server. The default system watch may include system monitoring parameters and the corresponding threshold values of the system monitoring parameters. The threshold values may be indicative of the permissible limit for value of the system monitoring parameters. For example, the threshold value of a system monitoring parameter “free memory”, in a system watch for a system, may be 5 MB. In case, the “free memory” for the system is less than the threshold value (5 MB), it may indicate an undesirable state of the system.

The system watch related input may also be received from a user for building or editing system watches. For building a system watch, the user may provide system monitoring parameters to be included in the system watch and the corresponding threshold values of the system monitoring parameters. A user may also edit an existing system watch based on their deployment scenario. For editing a system watch, the system watch related input may provide system monitoring parameters of one of the existing watches and revised threshold values corresponding to the system monitoring parameters. For example, three system watch related inputs may be received from a user for generating or editing system watches:
1) m1>2∥m2<3∥m3>5 (where, m1, m2, and m3 are the system monitoring parameters and 2, 3, and 5 are the threshold values for m1, m2, and m3, respectively), for generating a first system watch.
2) m2>4∥m3<2, for generating a second system watch.
3) m1<3∥m2>7, (for editing the threshold values of system monitoring parameter m1 and m2).

In the above example, the system watch related inputs include logical disjunction (represented by the ∥ symbol) of two or more system monitoring parameters m1, m2, and m3. In one embodiment, the system watch related inputs may include logical conjunction of system monitoring parameters. In yet another embodiment, the system watch related inputs may include a bracket operator for creating a sub-group of system monitoring parameters.

The system watch related input may also include corrective actions defined for the created system watches. Corrective actions are executed whenever the system watch identifies an undesirable state of the system. In one embodiment, corrective actions are executed when a value of a system monitoring parameter, included in the system watch, exceeds the corresponding threshold value. Corrective actions may be defined to bring the system to a normal state from the undesirable state. For example, consider a system watch including a system monitoring parameter “server load”. In this case, a corrective action may be defined to generate “a cloned server”, for sharing the “system load”, when the value of the “server load” is greater than the threshold value (undesirable state of the system). In one embodiment, the corrective action is configured in form of a probe. A probe is a utility that provides the ability to monitor a system using simulated application. Users can run a probe to check the system health at any given time. The result of execution of the probe may be made available to the user.

Next at block 204, system monitoring parameters are retrieved from the system watch related input received at block 202. In the above example, system monitoring parameters, m1, m2 and m3 are retrieved from the three system watch related inputs. Next at block 206, a support value is computed for the retrieved system monitoring parameter. In one embodiment, support value of a system monitoring parameter is the percentage of the system watch related inputs that includes the system monitoring parameter. That is, for a given monitoring parameter, the support value is the quotient of the number of system watch related inputs containing the parameter and the total number of watch related inputs. In the above example, the support value of the system monitoring parameter m1 is 2/3, as m1 is included in two system watch related inputs (input 1 and 3) of the total three inputs. Similarly, the support value of the system monitoring parameters m2 and m3 are determined as 3/3 and 2/3, respectively.

Next, at block 208, the system monitoring parameters retrieved at block 204 are filtered based on the support values of the system monitoring parameters computed at block 206. The system monitoring parameters may be filtered by comparing the computed support value of the system monitoring parameters with a pre-determined minimum support value. The minimum support value may be set by a user such as a system administrator. For example, the minimum support value may be set as 0.25 by the system administrator. In case, the computed threshold value of a system monitoring parameter is less than 0.25 then the system monitoring parameter may be discarded during the filtering operation.

In one embodiment, an Apriori algorithm is used for filtering the retrieved system monitoring parameters. An Apriori algorithm is a filtering algorithm for discarding the system monitoring parameters that have a support value less than the minimum support value. The Apriori algorithm takes as input the system monitoring parameters retrieved at block 204 and their corresponding support values computed at block 206 and, based on the input, computes a filtered set of system monitoring parameters that includes system monitoring parameters having a support value greater than or equal to the minimum support value (block 210). The Apriori algorithm compares the computed support values of the system monitoring parameters retrieved at block 204 with the predetermined minimum threshold value. In case the support value of a system monitoring parameter from among the system monitoring parameters retrieved at block 204 is less than the minimum support value, then that system monitoring parameter may be discarded. In one embodiment, the Apriori algorithm performs a level based filtering on the system monitoring parameters retrieved at block 204. At each level the Apriori algorithm compares the support values of the system monitoring parameters with the minimum support value and discards the system monitoring parameters that have a support value lesser than the minimum support value. During the level based filtering, each level of system monitoring parameters is obtained by joining the system monitoring parameters obtained after performing the filtering operation at the previous level. In one embodiment, the first level of filtering, during the level based searching, is performed on the system monitoring parameters retrieved at block 204. The system monitoring parameters obtained after filtering at each level are added to a filtered set of system monitoring parameters (block 210). The system monitoring parameters which do not satisfy the condition in block 208 are discarded (block 212). In one embodiment, the system monitoring parameters retrieved at block 204 are partitioned into many partitions and the Apriori algorithm may be applied separately on each of the partitions. The system monitoring parameters may be partitioned according to the number of available multi core CPU's on which the Apriori algorithm can run. The results obtained at each partition may be merged together to obtain the filtered set of system monitoring parameter.

In the above example, consider that an administrator sets the minimum support value as 2/3. The first level of item sets, for the Apriori algorithm, includes the system monitoring parameters m1, m2, and m3. As the support values (2/3, 3/3, and 2/3) of the system monitoring parameters m1, m2, and m3, respectively, are greater than equal to the minimum support value, each of the system monitoring parameters m1, m2, and m3 are added to the filtered set of system monitoring parameters. Next, the system monitoring parameters m1, m2, and m3 are joined together to obtain three system monitoring parameters (m1m2), (m1m3), and (m2m3), which are the second level of system monitoring parameters. The support value for m1m2 is 2/3, as the combination of m1 and m2 is present in two inputs (input 1 and 3) of the three inputs. Similarly, the support value for m1m3 and m2m3 are determined as 1/3 and 2/3, respectively. As the support values of m1m2 and m2m3 are greater than equal to 2/3, m1m2 and m2m3 are added to the filtered set of system monitoring parameters. Next a third level of system monitoring parameters is generated by combining the system monitoring parameter (m1m2) and (m2m3) obtained after the filtering operation at level 2. The third level includes the system monitoring parameter m1m2m3, which includes three subsets (m1m2), (m1m3), and (m2m3). As one of the subsets m1m3 is not included in the filtered set of system monitoring parameters, based on the Apriori property, the system monitoring parameter (m1m2m3) is not added to the filtered set of system monitoring parameters. As no other level can be created, the Apriori algorithm terminates. The obtained filtered set of system monitoring parameters include m1, m2, m3, m1m2 and m2m3.

Next, at block 214 a posterior probability is computed for the filtered set of system monitoring parameters. In Bayesian statistics, the posterior probability of a random event or an uncertain proposition is the conditional probability that is assigned after the relevant evidence is taken into account. The posterior probability may be computed for a pair of system monitoring parameters, included in the filtered set of system monitoring parameters obtained at block 212. In probability theory, the “conditional probability” of an event “A” with respect to an event “B” is the probability of an event “A” to occur if the event “B” is known to occur. In one embodiment, the conditional probability, represented by expression P (A|B), of an event A to occur when an event B is known to occur, may be determined based on a joint probability, represented by P (A∩B), of the event A and the event B. The joint probability of event A and B may be defined as the probability of event A and event B, defined over a same probability space, to occur together at the same time. In one embodiment, for determining the joint probability of the pair of system monitoring parameters, included in the filtered set of system monitoring parameters, the probability space may be the system watch related inputs received at block 202. The joint probability of the pair of system monitoring parameters may be the quotient of the number of system watch related inputs, from the system watch related inputs received at block 202, including the pair of system monitoring parameters and the total number of system watch related inputs received at block 202. In one embodiment, the posterior probability (conditional probability) is defined as the quotient of the joint probability of the events A and B over a probability space and the probability of event B over the same probability space. The posterior probability of the pair of system watch related inputs may be defined as the quotient of the joint probability of the pair of system monitoring parameters with respect to the system watch related inputs received at block 202 and the probability of one of the pair of system monitoring parameters with respect to the system watch related inputs received at block 202. In the above example, consider a pair of system monitoring parameters m1 and m2 from the filtered set of system monitoring parameters then the posterior probability P (m1|m2) may be determined based on the joint probability of m1 and m2 P (m1∩m2) with respect to the probability of m2 P (m2).

P (m1|m2)=P (m1∩m2)/P(m2), where P(m1∩m2) is the joint probability of system monitoring parameters m1 and m2 occurring together in the system watch related input received at block 202; and

P(m2) is the probability of system monitoring parameter m2 occurring in the system watch related input received at block 202, where
P(m2)=Total number of occurrences of system monitoring parameter m2 in the system watch related input/total number of system watch related inputs.

In one embodiment, the determined posterior probability of each pair of system monitoring parameters, included in the filtered set of system monitoring parameters, may be stored in a posterior probability matrix. Each element of the posterior probability matrix stores the posterior probability of one of the system monitoring parameter in the filtered set with respect to another system monitoring parameter of the filtered set. The posterior probability matrix may be stored in the system monitoring parameter database (block 218). In the above example, the posterior probability is determined for each pair of system monitoring parameters m1, m2, m3, m1m2 and m2m3. For example, the posterior probability for the system monitoring parameter m1 may be determined with respect to m2 (P (m1|m2)), m3 (P (m1|m3)), m1m2 (P (m1|m1m2)), and m2m3 (P (m1|m2m3)). Similarly, the posterior probability for the system monitoring parameter m2 may include P (m2|m1), P (m2|m3), P (m2|m1m2), and P (m2|m2m3). For example, the posterior probability P (m1|m2)=2/3 (joint probability of system monitoring parameters m1 and m2 occurring together in the system watch related inputs)/3/3 (probability of occurrence of m2 in the system watch related inputs). The computed posterior probability P(m1|m2)=2/3 or 0.6 indicates the probability of a system monitoring parameter m1 to be present in a system watch related input that also includes both the system monitoring parameter m1 and m2. The determined posterior probability may be stored in the posterior probability matrix. In the above example, the posterior probability matrix may store the values of the posterior probabilities P (m1|m2), P (m1|m3), P (m1|m1m2), and P (m1|m2m3) for the system monitoring parameter m1.

Next at block 216, a genetic algorithm is applied on the posterior probability determined at block 214. In one embodiment, the genetic algorithm is applied on the posterior probability matrix generated at block 214. Genetic algorithm is a search heuristic that mimics the process of natural evolution. The genetic algorithm may be used for generating useful solutions to optimization and search problems. Optimization refers to the selection of a best element from some set of available alternatives. In one embodiment, the genetic algorithm may be used for determining an optimal correlation between the system monitoring parameters included in the filtered set of system monitoring parameters obtained at block 210. Correlation is the degree in which two quantities are associated. Two system monitoring parameters may be correlated if they have a probability of occurring together in the system watch related input received at block 202. In the above example, genetic algorithm may be applied to the posterior probability matrix to determine the correlation between the system monitoring parameters m1, m2, m3, m1m2m3, and m2m3. For example, the correlation between system monitoring parameters m1 and m1m2 may be determined as an indirect correlation m1→m2→m1m2 (which means that m1 has a highest probability of occurrence with m2 and m2 has a highest probability of occurrence with m1m2). In one embodiment, the genetic algorithm generates a correlation list of system monitoring parameters, from the filtered set of system monitoring parameters, which are correlated with each other. The correlation list of system monitoring parameters represents the optimal correlation between the system monitoring parameters included in the filtered set of system monitoring parameters. The correlation list is a linked list of the system monitoring parameters, included in the filtered set of system monitoring parameters, arranged according to the sequence of correlation between the system monitoring parameters. In the above example, the correlation list is a linked list that includes (m1→m2→m1m2) that shows the linkage between system monitoring parameters m1, m2, and m1m2. The determination of the correlation list for the system monitoring parameters, included in the filtered set of system monitoring parameters, may be considered analogous to determining a shortest distance between two points A and B. Consider that, based on a posterior probability values P (A|B), P (A|CB), and P (A|DB) in a posterior probability matrix, a person can reach point B from point A via three routes: a first direct route from A to B which is for example 2 miles, a second indirect route from A to C, which is 0.7 miles, and then from C to B, which is 0.3 miles, and a third indirect route from A to D, which is 2 miles, and then from D to B, which is 0.1 miles. The genetic algorithm may be applied on the posterior probability matrix to determine that the shortest possible distance between A and B is the second indirect route A to C and C to B. The correlation list in this case is a linked list that includes points A, C, and B (A→C→B).

The genetic algorithm may use a “selection” operation, a “cross over” operation, and a “mutation” operation. The genetic algorithm may initially create a population set, where each element of the population set contains the posterior probability matrix. Next an improved population set may be generated by randomly selecting pairs of elements from the population set and then performing a “cross over” operation and a “mutation” operation on the selected pair. The “cross over” operation generates offspring by crossbreeding parents and is an operation for permuting a part of a gene of an entity. For the cross over operation the randomly selected elements of the population set represent parents. In one embodiment, the cross over operation used a two split technique, for producing the offspring, which may include selecting, portions from each parents and mixing the portions to obtain the offspring. For example, if a first parent includes bits 11110010 and a second parent element includes bits 01011101 then a first offspring (11111101) may be generated by mixing the first four bits of the first parent with the last four bits of the second parent, and a second offspring (11011111) may be generated by mixing the first four elements of the second parent with the last four bits of the first parent element. Next the “mutation” operation is performed on the offspring obtained by the cross over operation. Mutation alters one or more values of the generated offspring from its initial state. The genetic algorithm may initially generate two random mutation percentages and then compare the generated random mutation percentages with a predefined mutation percentage value. In case, the first mutation percentage is greater than the predefined mutation percentage then the genetic algorithm mutates the first generated offspring to obtain a first mutated offspring. Similarly, if the second mutation percentage is greater than the predefined mutation percentage then the genetic algorithm mutates the second offspring to obtain a second mutated offspring. In the above example, based on a comparison, a determination may be made to mutate the first offspring 11111101. In this case, the bit values of the first offspring may be changed at location 2 and 4 to obtain the mutated first offspring 10101101. The offspring obtained after the mutation operation are merged into an improved population set. The process of “selection”, “cross over”, and “mutation” is repeated until an offspring is generated for each element in the population set. The genetic algorithm then repeats the process of “cross over” and “mutation” on the improved population set until same offspring are obtained in the improved population set for a pre-determined number of times. During each iteration, the genetic algorithm may analyze one possible correlation between pair of system monitoring parameters included in the filtered set of system monitoring parameter. The improved population set obtained at the end of the iterations may identify the correlation list that includes system monitoring parameters correlated to each other.

In the above example, the genetic algorithm is applied to the posterior probability matrix that includes the posterior probabilities of system monitoring parameters m1, m2, m3, m1m2, and m2m3. The generic algorithm tries to obtain the optimal correlation between each pair of the system monitoring parameters m1, m2, m3, m1m2, and m2m3 based on the posterior probability matrix. For example with respect to m1, the genetic algorithm tries to determine the optimal correlation between m1 and m2, m1 and m3, m1 and m1m2, and m1 and m2m3. Based on the posterior probability stored in the posterior probability matrix, a possible correlation between the pair of system monitoring parameters is analyzed during each iteration of the genetic algorithm. For example, with respect to the correlation between system monitoring parameter m1 and m2, during a first iteration the genetic algorithm may analyze the direct correlation m1→m2. During a second iteration the genetic algorithm may analyze an indirect correlation m1→m1m2→m2. The genetic algorithm continues to perform the iteration until the same offspring are produced in the improved population. The improved population obtained at the end of the iteration may identify the correlation list of system monitoring parameters correlated to each other. The correlation list identified, for the above example, may include the direct correlation m1→m2, which represents the optimal correlation between m1 and m2. Similarly, the correlation lists are identified for correlation between m1 and m3, m1 and m1m2, and m1 and m2m3.

Next at block 220, threshold values for the filtered set of system monitoring parameters (obtained at block 210) are retrieved from the system watch related inputs received at block 202. The threshold values of a system monitoring parameter include a minimum value (caution threshold value) and a maximum value (danger threshold value) of the system monitoring parameter in the system watch related inputs received at block 202. In one embodiment, the threshold value of a system monitoring parameter in the filtered set may be retrieved with respect to another system monitoring parameter of the filtered set of system monitoring parameters obtained at block 210. In this case, the threshold values (caution threshold value and danger threshold value) of the system monitoring parameters may be retrieved from only those system watch related inputs that includes the system monitoring parameter and the another system monitoring parameter. In the above example, the threshold values of the system monitoring parameter m1 is {2,3} (minimum and maximum threshold values of m1 in the three system watch related inputs), the threshold value of system monitoring parameter m1 with respect to m2 is {2,3} (minimum and maximum threshold values of m1 in the system watch related input 1 and 3 that includes both m1 and m2), the threshold value of m1 with respect to m3 is {2,2} (maximum and minimum values are same as m1 and m3 are together in only equation 1), the threshold value of m1 with respect to m1m2 is {2,3} (minimum and maximum threshold values of m1 in the system watch related input 1 and 3 that includes both m1 and m1m2), and the threshold value of m1 with respect to m2m3 is (2,2) (maximum and minimum values are same as m1 and m3 are together in only equation 1). Similarly, the threshold values of m2, m3, m1m2, and m2m3 are determined.

Next at block 222, the determined threshold values of the filtered set of system monitoring parameters, at block 220, may be stored in the system monitoring parameter database. In one embodiment, the determined threshold values may be stored in a threshold matrix. Each element of the threshold matrix stores the threshold value of a system monitoring parameter with respect to another system monitoring parameter from the filtered set. The determined threshold matrix may be stored in the system monitoring parameter database. In the above example, the row of the threshold matrix corresponding to the system monitoring parameter m1 may store the threshold values for m1, m1 with respect to m2, m1 with respect to m3, m1 with respect to m1m2, and m1 with respect to m2m3.

Next at block 224, system watch related equations are generated based on the correlation list determined at block 216 and the threshold values of the filtered set retrieved at block 220. In one embodiment, the threshold values of the system monitoring parameters included in the correlated list are identified from the threshold values retrieved at block 220. The threshold values of one of the system monitoring parameter in the correlation list may be identified with respect to other system monitoring parameters in the correlation list. The system watch related equations includes the system monitoring parameters included in the correlated list and the corresponding threshold values of these system monitoring parameters. In one embodiment, the system watch related equations includes two equations 1) a caution system watch equation which includes the system monitoring parameters included in the correlation list and the corresponding caution threshold values (minimum value), and 2) a danger system watch equation which includes the system monitoring parameters included in the correlated list and the corresponding danger threshold values (maximum value). In the above example, the correlation list is determined as m1→m2, where the symbol → represents correlation between two system monitoring parameters. The minimum threshold value (caution threshold value) and maximum threshold value (danger threshold value) for the system monitoring parameter m1 and m2 are determined as {2, 3} and {3, 7} (from system watch related input 1 and 2 that includes both m1 and m2). A caution system watch equation (m1>2∥m2<3) and a danger system watch equation (m1<3∥m2>7) is then generated using the correlation list and the caution and danger threshold values, respectively, of m1 and m2. Finally at block 226, the system watch related equations generated at block 224 are stored in the system monitoring parameter database.

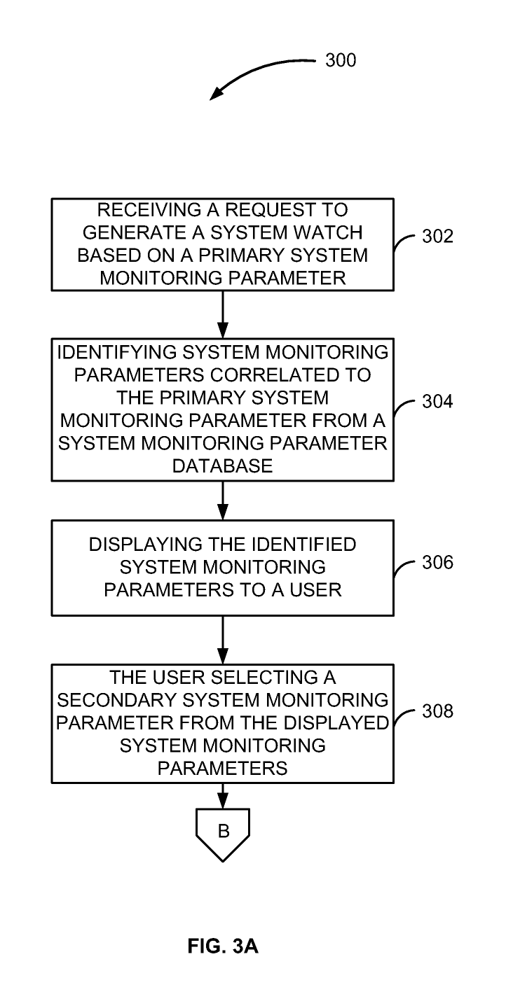

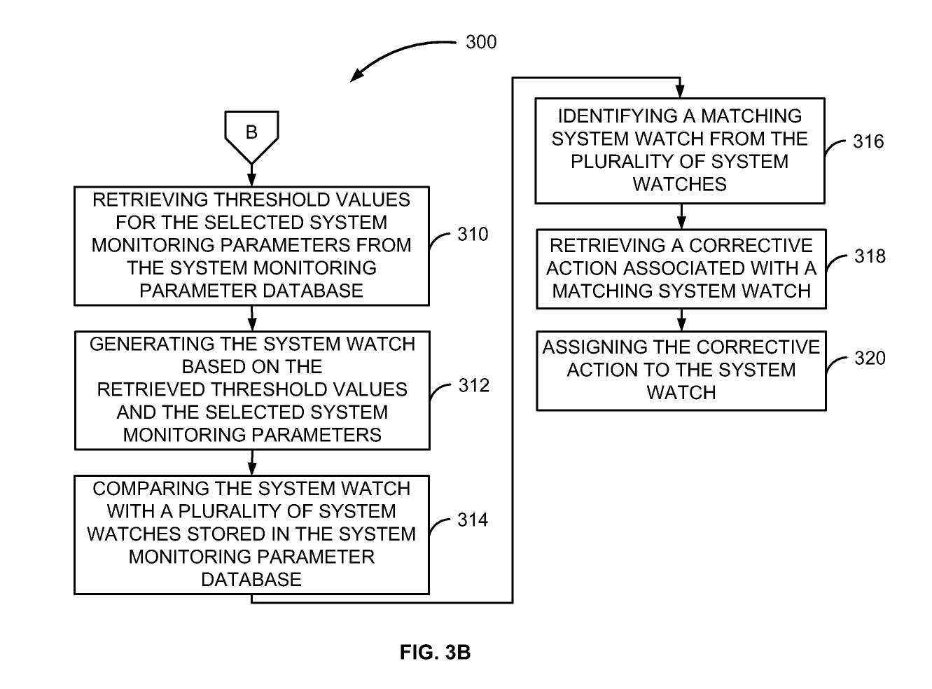

FIGS. 3A-3B is a flow diagram 300 illustrating a method for monitoring a system based on the system monitoring parameter database built in FIGS. 2A-2B, according to an embodiment. Initially at block 302 a request is received to generate a system watch for monitoring a system. A system watch is an entity that can be used to monitor the state of the system, and to alert a user or trigger corrective actions if the system is not working properly. The system watch monitors the system based on system monitoring parameters. In one embodiment, the request to generate the system watch is received from a user. The request to generate the system watch may include a primary system monitoring parameter, which the user wants to be included in the system watch. For example, a request from a user to generate a system watch for a memory system may include a system monitoring parameter “server load” that the user wants to be included in the system watch.

Next at block 304, system monitoring parameters correlated to the primary system monitoring parameter are identified from the system monitoring parameter database. As discussed above, the system monitoring parameter database stores correlation list of system monitoring parameters. The system monitoring parameters correlated to the primary system monitoring parameter database are identified from the correlation list stored in the system monitoring parameter database. In the above example, the system monitoring parameter database may store a correlation list that is a linked list including system load→number of current user sessions→number of events in queue. Based on this list, system monitoring parameters “number of current user sessions” and “number of events in queue” are identified as correlated to the primary system monitoring parameter “system load.”

Next at block 306, the system monitoring parameters identified as correlated to the system monitoring parameter are displayed on a user interface. A user may then select a secondary system monitoring parameter from the displayed system monitoring parameter at block 304 (block 308). The user may select any number of system monitoring parameters from the system monitoring parameters displayed to the user. In the above example, the system monitoring parameters “number of current user sessions” and “number of events in queue” may be displayed to a user. The user may select the system monitoring parameter “number of current user sessions” from the displayed system monitoring parameters.

Next at block 310, the threshold values of the primary system monitoring parameter and the secondary system monitoring parameter (selected at block 308) are retrieved from the system monitoring parameter database. The threshold values may be retrieved from the threshold matrix stored in the system monitoring parameter database. The threshold values retrieved may include the caution threshold value and the danger threshold value for the primary and the secondary system monitoring parameters. The threshold values of the primary system monitoring parameter and the secondary system monitoring parameter may be retrieved from the system watch related inputs that include both the primary and the secondary system monitoring parameters. In the above example the threshold values retrieved for the primary system monitoring parameter “system load” may be {10, 15} and the secondary system monitoring parameter “number of current user sessions” may be {1,5}.

Next at block 312, the system watch is generated based on the primary and the secondary system monitoring parameters and their corresponding threshold values retrieved at block 310. In one embodiment, system watch equations are generated based on the primary system monitoring parameter and the secondary system monitoring parameter and their corresponding threshold values. The generated system watch equations form the system watch of the system. In one embodiment, the generated system watch includes a caution system watch equation and a danger system watch equation generated based on the primary and the secondary system monitoring parameters and their corresponding caution and danger threshold values. The system watch monitors the system based on the generated system watch equations. In one embodiment, the system watch changes its state based on the threshold values in the system watch equations. The state of the watch may indicate the state of the system being monitored by the watch. For example, the system watch may be in one of: an ok state, a caution state, or a danger state. The ok state of the system watch indicates that the system is working properly. The system watch may be in the ok state when the values of the primary and secondary system monitoring parameters included in the system watch related equations are less than their corresponding caution threshold values (minimum values). The caution state of the system watch may indicate an undesirable state of the system and is a warning that the system is not functioning properly. The system watch may be in the caution state when the value of at least one of the primary and secondary system monitoring parameters is greater than their corresponding caution threshold values. The danger state of the system watch may indicate a critical state of the system. The system watch may be in the danger state when the value of at least one of the primary and secondary system monitoring parameters is greater than the danger threshold values (maximum values) of these parameters. A user may associate an alert to the system watch, which may notify the user of a state change of the watch. In the above example, the system watch may include a caution system watch equation (system load>10∥number of current user sessions>1) and a danger system watch equation (system load<15∥number of current user sessions<5).

Next at block 314, the generated system watch is compared with the system watches included in the system monitoring parameter database. As discussed above, the system watch related input, included in the system monitoring parameter database, may include custom system watches or system watches generated based on user input. In one embodiment, the comparison is performed by comparing the system monitoring parameters in the generated system watch with the system monitoring parameters in the system watches included in the system watch related input. Based on the comparison, a matching system watch is identified from the system watches included in the system watch related input (block 316). In one embodiment, a matching system watch is a system watch that has maximum number of matching system monitoring parameters identical with the system monitoring parameters of the generated system watch. As discussed above, the system watch related input includes a corrective action corresponding to the system watches. The corrective action corresponding to the matching system watch is retrieved from the system watch related input (block 318). Finally, the retrieved system watch related input is assigned to the generated system watch (block 320).

In one embodiment, if an exact matching system watch (a system watch that has all the system monitoring parameters identical with the system monitoring parameters of the generated system watch) is not identified then a system watch (best match) that has maximum number of system monitoring parameters identical with the generated system watch is identified (block 316). In this case, the best match system watch is presented to the user along with a corresponding matching percentage. Next, the user may either select the corrective action corresponding to the best match or modify the corrective action corresponding to the best match. Finally, the corrected or modified system monitoring parameter may be assigned to the generated system watch.

In one embodiment, a system watch for a second system may be generated based on a corrective action of a first system watch. In this case, a copy of the system watch of the first system may be created and assigned to the second system watch. For example, if the corrective action of a first system is to “create a clone” of the first system watch, then a copy of a system watch related to the first system may be created and assigned to the created clone of the first system.

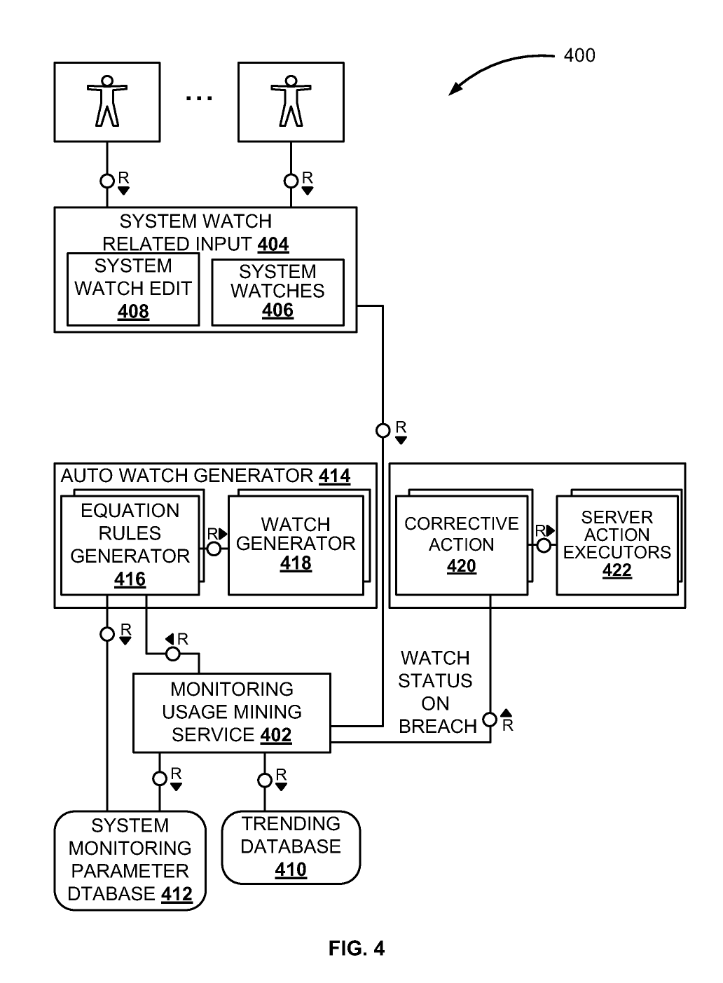

FIG. 4 is a block diagram illustrating a system 400 for generating a system watch, according to an embodiment. The system 400 includes a monitoring usage mining service 402 that receives a system watch related input 404 received from users. As shown, the system watch related input 404 includes system watches 406 (default system watches or user generated system watches) and system watch edits 408 for editing the system watches 406. The monitoring usage mining service 402 updates the system watch related input 404 in a trending database 410. Updating of the trending database 410 may be performed periodically whenever any one of the system watches 406 are executed. Further, updating of the trending database 410 may also be performed whenever a new system watch is created. The trending database 410 stores the system monitoring parameters, and their corresponding threshold values, included in the system watch related input 404. A correlation may be determined between the system monitoring parameters stored in the trending database 410 to generate a correlation list of system monitoring parameters. The generated correlation list may be stored in a system monitoring parameter database 412. Further, the threshold values of the system monitoring parameters may also be retrieved from the trending database 410 and stored in the system monitoring parameter database 412. In one embodiment, a threshold value received in the system watch related input 404 may be directly updated in the system monitoring parameter database 412.

A request for generating a system watch may be received by an auto watch generator 414. Based on the received request, an equation rule generator 416, included in the auto watch generator 414, may generate system watch equations using the system monitoring parameter correlation list and the threshold values stored in the system monitoring parameter database 412. A watch generator 418, included in the auto watch generator 414, then generates the system watch using the generated system watch equations. Finally the generated system watch is associated with a corrective action 420. The corrective action 420 triggers a server action executor 422 to take the necessary corrective actions when the threshold values of the generated system watch are breached.

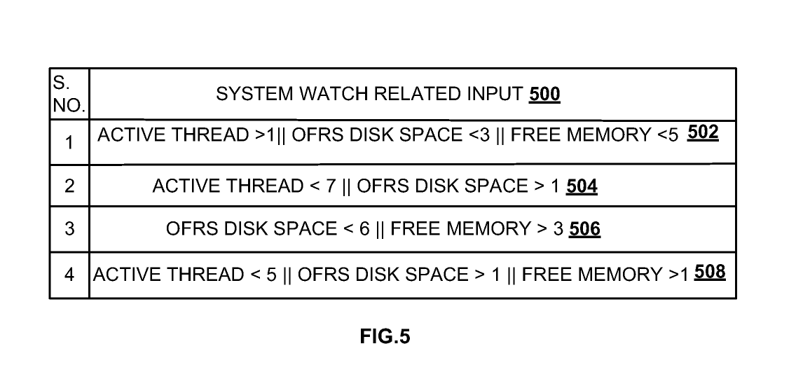

FIG. 5 is an exemplary block diagram illustrating system watch related input 500, according to an embodiment. The system watch related input 500 may include four inputs 502, 504, 506, and 508 for creating or editing system watches.

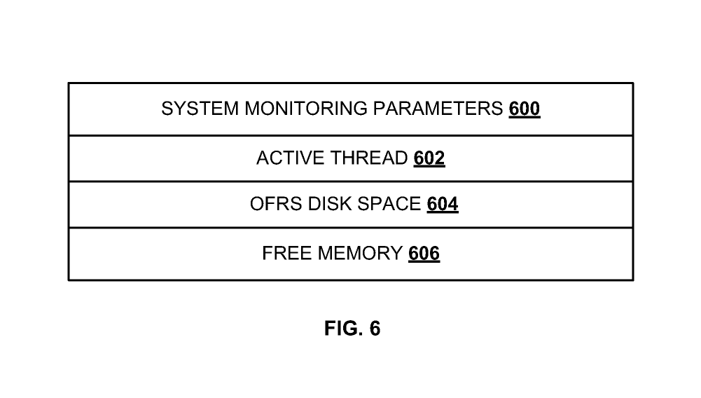

FIG. 6 is an exemplary block diagram illustrating system monitoring parameters 600 retrieved from the system watch related input 500 of FIG. 5, according to an embodiment. As shown, three system monitoring parameters “active thread” 602, “ofrs disk space” 604, and “free memory” 606 are retrieved from the system watch related input 500 of FIG. 5.

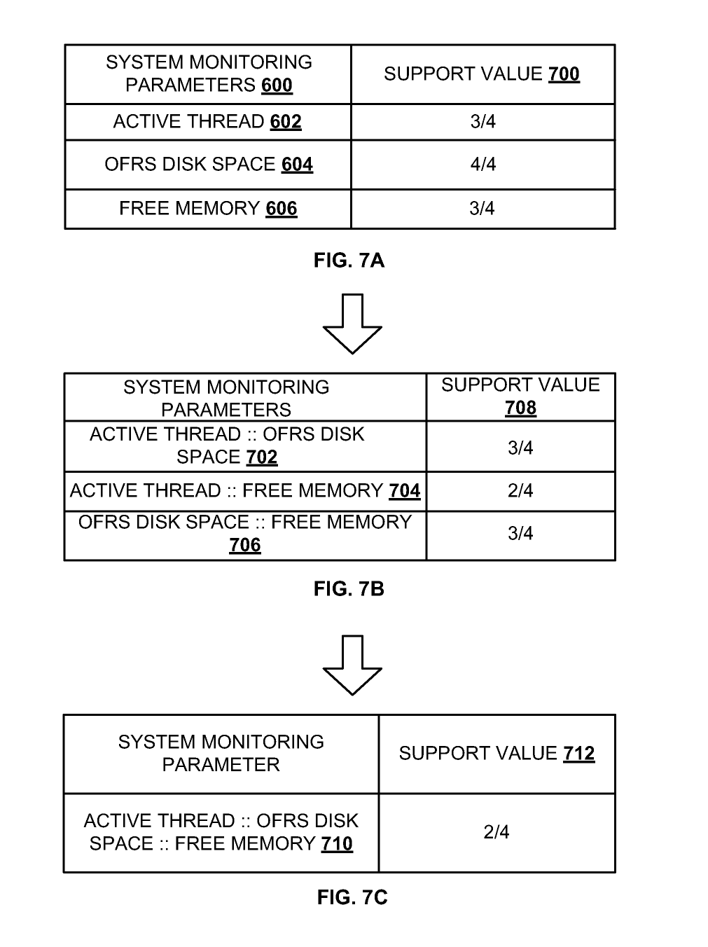

FIGS. 7A-7C are exemplary block diagrams illustrating filtering of the system monitoring parameters 600 of FIG. 6, according to an embodiment. An Apriori algorithm is applied on the system monitoring parameters 600 for filtering the system monitoring parameters 600. The pre-defined minimum support value for filtering the system monitoring parameters 600 is set as 2/4. The Apriori algorithm performs a level based filtering of the system monitoring parameters 600. The system monitoring parameters obtained, after filtering, at each level are added to a filtered set of system monitoring parameters. FIG. 7A illustrates the first level of filtering of the system monitoring parameters 600. Initially, a support value 700 is computed for the system monitoring parameters 600. The support value 700 of the system monitoring parameter “active thread” 602 is computed as 3/4, as “active thread” 602 is present in three system watch related inputs (502, 504, and 508, FIG. 5) of the four system watch related inputs 502, 504, 506, and 508 of FIG. 5. Similarly the support value 700 for the system monitoring parameters 604 and 606 are determined as 4/4 and 3/4, respectively. As the support values 3/4, 4/4 and 3/4 corresponding to the system monitoring parameters “active thread” 602, “ofrs disk space” 604, and “free memory” 606, respectively, are greater than or equal to the minimum support value 2/4, all the three system monitoring parameters 602, 604, and 606 are added to the filtered set of system monitoring parameters.

Next a second level of filtering is performed based on the system monitoring parameters 602, 604, and 606 obtained after the first level of filtering. FIG. 7B illustrates a second level of filtering of the system monitoring parameters 600. The second level filtering is performed by joining the system monitoring parameters 602, 604 and 606 obtained after the first level of filtering in FIG. 7A. The system monitoring parameter 702 “active thread:: ofrs disk space” is obtained by joining the system monitoring parameters 602 “active thread” and system monitoring parameter 604 “ofrs disk space”. Similarly, the system monitoring parameter 704 “active thread :: free memory” and the system monitoring parameter 706 “ofrs disk space :: free memory” are obtained by joining the system monitoring parameters 602 and 606, and the system monitoring parameters 604 and 606, respectively. Next, a support value 708 is determined for the system monitoring parameters 702, 704, and 706. A support value 3/4 is determined for the system monitoring parameter 702 “active thread :: ofrs disk space” as the combination of “active thread” 602 and “ofrs disk space” 604 is present in three system watch related inputs (502, 504 and 508, FIG. 5) of the four system watch related inputs 502, 504, 506, and 508 of FIG. 5. Similarly the support value 708 for the system monitoring parameters 704 and 706 are determined as 2/4 and 3/4, respectively. The system monitoring parameters “active thread :: ofrs disk space” 702, “active thread :: free memory” 704, and “ofrs disk space :: free memory” 706 that have support values 708 greater than or equal to the minimum support value 2/4 are added to the filtered set of system monitoring parameters. Next a third level of filtering is performed on the system monitoring parameters obtained after the second level of filtering. FIG. 7C illustrates a third level of filtering of the system monitoring parameters 600 of FIG. 6. The third level of filtering is performed by joining the system monitoring parameters 702, 704, and 706 obtained after the second level of filtering. A system monitoring parameter 710 “active thread :: ofrs disk space :: free memory” is obtained by joining the system monitoring parameters 702 and 706. A support value 2/4 (712) is determined for the system monitoring parameter “active thread :: ofrs disk space :: free memory” 710 as the combination of “active thread” 602, “ofrs disk space” 604, and “free memory” 606 is present in two system watch related input (502 and 508, FIG. 5) of the four system watch related inputs 502, 504, 506, and 508 of FIG. 5. As the support value of the system monitoring parameter 710 is equal to the minimum support value 2/4, the system monitoring parameter 710 is added to the filtered set of system monitoring parameters. As no other level can be generated based on the system monitoring parameter 710, the filtering process ends after the third level of filtering.

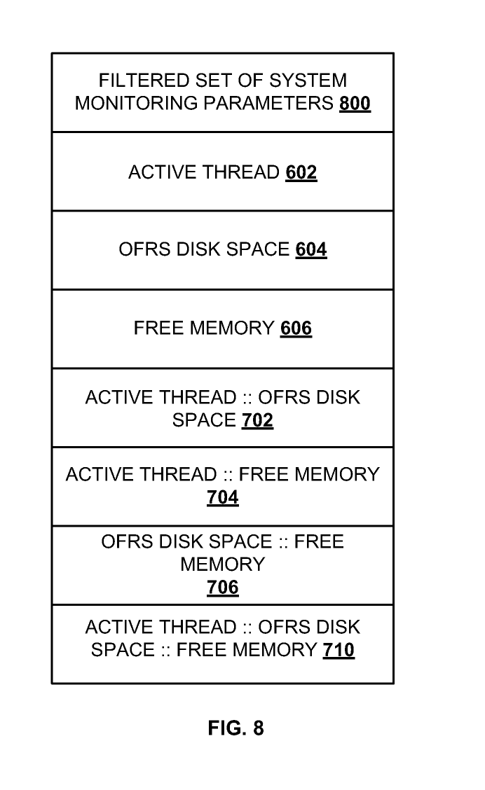

FIG. 8 is an exemplary block diagram illustrating a filtered set of system monitoring parameters obtained after the filtering operations of FIGS. 7A-C, according to an embodiment. The filtered set of system monitoring parameters 800 includes the system monitoring parameters “active thread” 602, “ofrs disk space” 604, “free memory” 606, the system monitoring parameters “active thread :: ofrs disk space” 702, “active thread :: free memory” 704, “ofrs disk space :: free memory” 706, and the system monitoring parameter “active thread :: ofrs disk space :: free memory” 710 obtained after the first, the second, and the third level of filtering in FIGS. 7A, 7B and 7C, respectively.

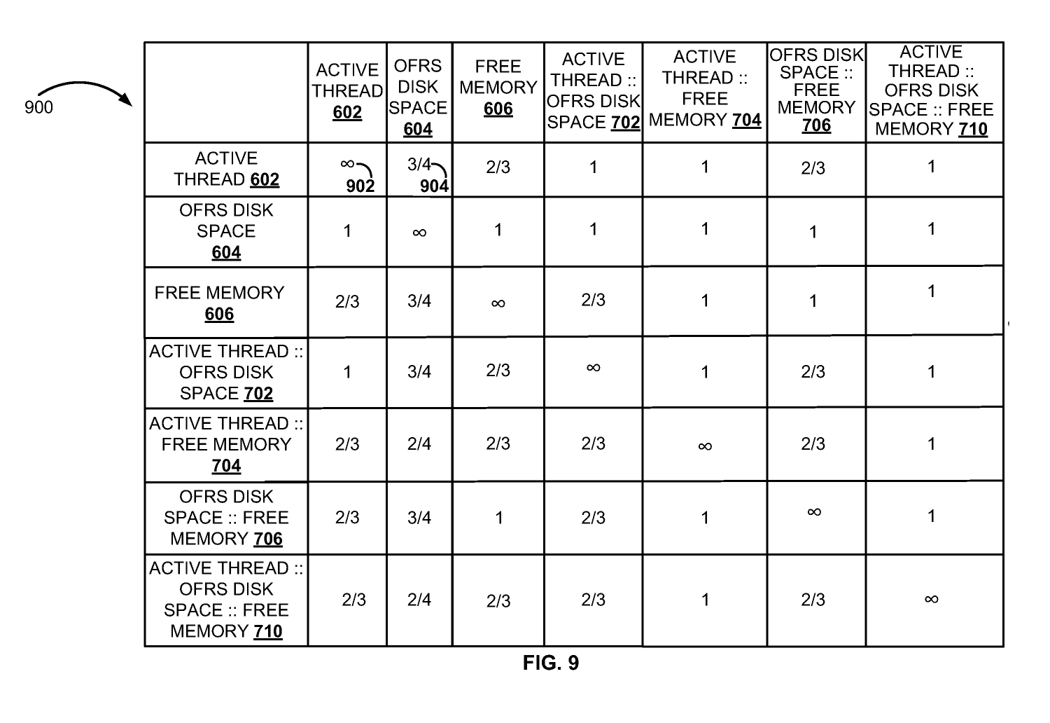

FIG. 9 is an exemplary block diagram illustrating a posterior probability matrix 900 for the filtered set of system monitoring parameters 800 of FIG. 8, according to an embodiment. The posterior probability matrix includes the posterior probability of each of the system monitoring parameters 602, 604, 606, 702, 704, 706, and 710 with respect to each other. The posterior probability of a system monitoring parameter with respect to itself is determined as ∞ (infinity), as the posterior probability of a system monitoring parameter to occur with itself is 100%. For example, the posterior probability 902 of system monitoring parameter “active thread” 602 with respect to itself is ∞. Similarly, the posterior probability of other system monitoring parameters 604, 606, 702, 704, 706, and 710 with respect to itself is also determined as ∞. The posterior probability 904 of system monitoring parameter “active thread” 602 with respect to the system monitoring parameter “ofrs disk space” 604 is determined as 3/4 (probability of “active thread” 602 and “ofrs disk space” 604 occurring together in system watch related input 500 of FIG. 5)/4/4 (probability of occurrence of “ofrs disk space” 604 in system watch related input of FIG. 5). The determined posterior probability 3/4 (902) of “active thread” 602 with respect to “ofrs disk space” 604 is stored in the posterior probability matrix 900. Similarly, posterior probability is determined between the system monitoring parameters, 602, 604, 606, 702, 704, 706, and 710, and the determined posterior probability values are stored in the posterior probability matrix 900. Genetic algorithm is then applied on the posterior probability matrix 900 to obtain a correlation list representing correlation between the system monitoring parameters 602, 604, 606, 702, and 706 included in the filtered set of system monitoring parameters 800.

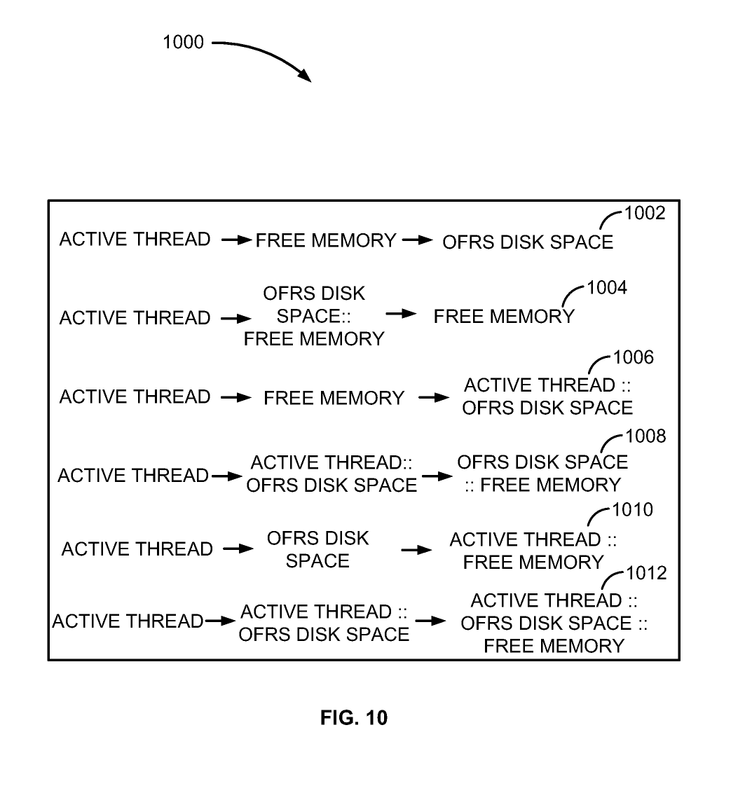

FIG. 10 is an exemplary correlation list 1000 obtained by applying a genetic algorithm on the posterior probability matrix 900 of FIG. 9, according to an embodiment. The correlation list 1000 includes linked lists 1002, 1004, 1006, 1008, 1110 and 1112 illustrating optimal correlation between the system monitoring parameter “active thread” 602 and the system monitoring parameters “ofrs disk space” 604, “free memory” 606, “active thread::ofrs disk space” 702, “active thread :: free memory” 704, “ofrs disk space :: free memory” 706, and “active thread :: ofrs disk space :: free memory” 710, respectively. Similarly, the correlation list 1000 may also include the optimal correlation between any of the system monitoring parameters 604, 606, 702, 704, 706 or 710 with respect to other system monitoring parameters 602, 604, 606, 702, 704, 706 and 710. Based on a result of the genetic algorithm, the optimal correlation between system monitoring parameter “active thread” 602 and “ofrs disk space” 604 is determined as an indirect correlation (active thread→free memory→ofrs disk space), as shown by the linked list 1002. Similarly the determined correlation between the system monitoring parameter “active thread” 602 and the system monitoring parameters 606, 702, 704, 706, and 710 are illustrated by lists 1004, 1006, 1008, 1010, and 1012, respectively.

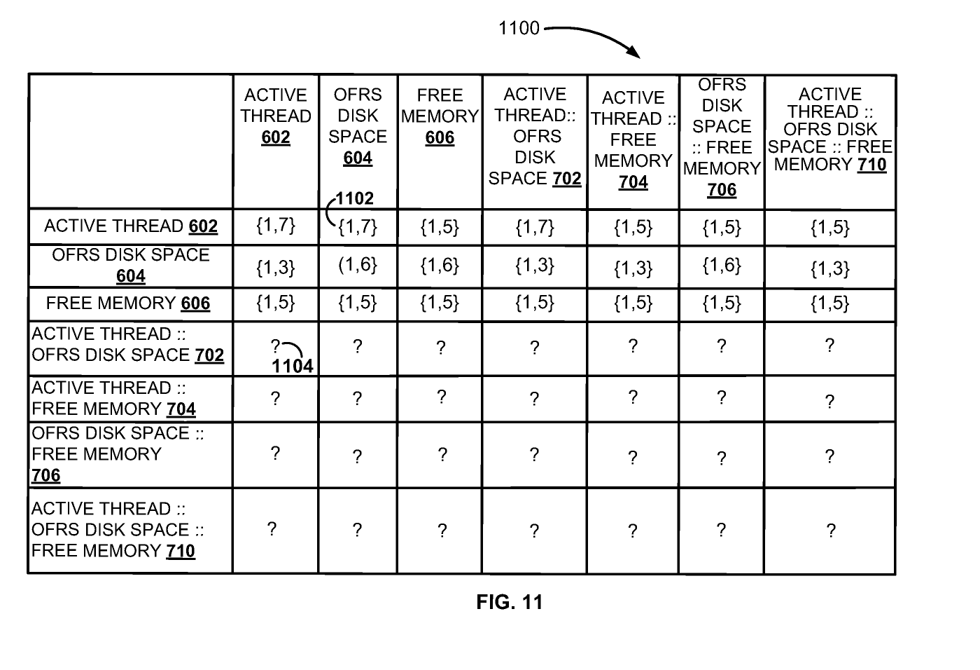

FIG. 11 is an exemplary block diagram illustrating a threshold matrix 1100 storing threshold values of the filtered set of system monitoring parameters 800 of FIG. 8, according to an embodiment. The threshold matrix 1100 stores the caution threshold value (minimum value) and the danger threshold value (maximum value) of a system monitoring parameter in the system watch related input 500 of FIG. 5. The threshold values of a system monitoring parameter, included in the filtered set 800 of FIG. 8, may be determined with respect to another system monitoring parameter included in the filtered set 800 of FIG. 8. For example, a threshold value {1,7} 1102 is determined for the system watch related input “active thread” 602 with respect to the system watch related input “ofrs disk space” 604. The threshold value 1102 includes the caution threshold value (1) and the danger threshold value (7) of the system monitoring parameter “active thread” 602 in the system watch related equations 502, 504, and 508 of FIG. 5 that include both the system monitoring parameters “active thread” 602 and “ofrs disk space” 604. As shown in FIG. 11, threshold values for a few system monitoring parameters, for example threshold value 1104 of system monitoring parameter “active thread :: ofrs disk space” 702 with respect to the system monitoring parameter “active thread” 602, are unknown, as represented by a question mark (?). The threshold value 1104 is unknown as the system watch related input 500 does not include values for the system monitoring parameter active thread :: ofrs disk space” 702. The threshold value 1104 may be determined at a later stage, when a system watch related input that includes values of system monitoring parameter “active thread :: ofrs disk space” 702 is received.

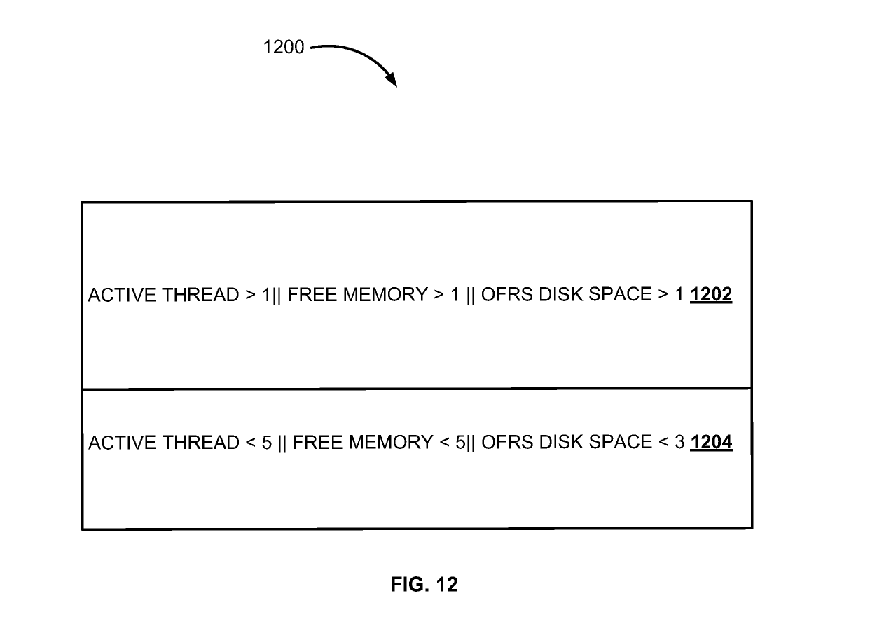

FIG. 12 is an exemplary block diagram 1200 illustrating system watch related equations 1202 and 1204 generated based on the correlation list 1000 of FIG. 10 and the threshold matrix 1100 of FIG. 11, according to an embodiment. The system watch related equations 1202 and 1204 are generated based on the linked list 1002 (active thread→free memory→ofrs disk space) included in the correlation list 1000 of FIG. 10 and the threshold matrix 1100 of FIG. 11. The threshold value of each of the system monitoring parameter “active thread” 602, “ofrs disk space” 604 and “free memory” 606 is determined with respect to other system monitoring parameters included in the linked list 1002. For example, the caution threshold value (1) and the danger threshold value (5) of the system monitoring parameter “active thread” 602 is determined with respect to the combination of system monitoring parameters “ofrs disk space” 604 and “free memory” 606 (ofrs disk space :: free memory (706)) included in the linked list 1002 of the correlation list 1000. Similarly, the caution and danger threshold values of the system monitoring parameters “free memory” and “disk space” are determined as {1, 5}, and {1, 3} respectively. Based on the determined threshold values, a caution system watch equation (active thread>1∥free memory>1∥ofrs disk space>1) 1202 is generated that includes the system monitoring parameters “active thread” 602, “free memory” 604, and “ofrs disk space” 606 and the corresponding caution threshold values 1, 1, and 1, respectively. Similarly, based on the determined threshold values, a danger system watch equation (active thread<5∥free memory<5∥ofrs disk space<3) 1204 is generated that includes the system monitoring parameters “active thread” 602, “free memory” 604, and “ofrs disk space” 606 and the corresponding caution threshold values 5, 5, and 3, respectively.

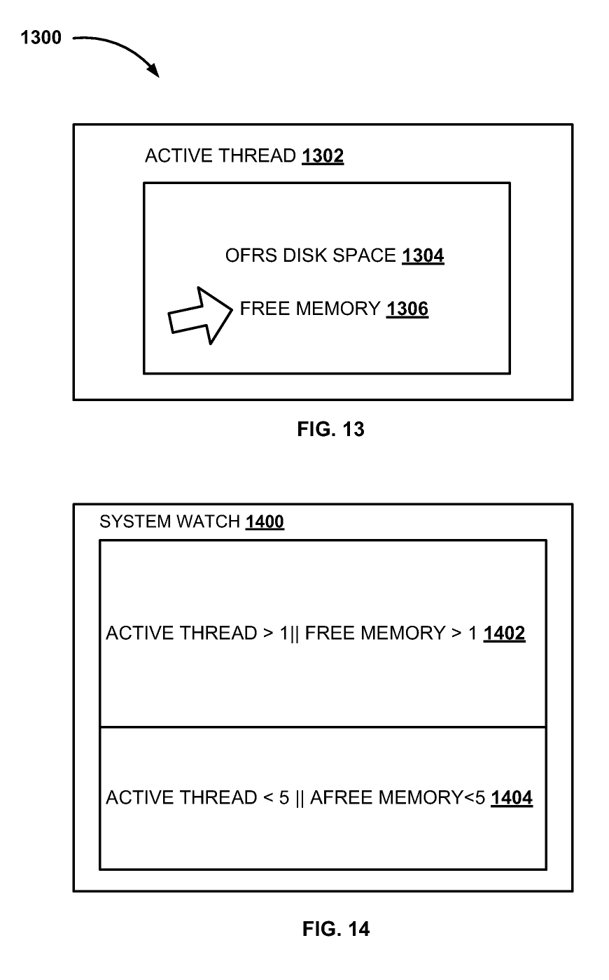

FIG. 13 is an exemplary user interface displaying correlated system monitoring parameters 1302 and 1304 based on a received user request 1306, according to an embodiment. The user request 1306 is received from a user for generating a system watch for a system. The user request includes a primary system monitoring parameter “active thread” 1306, which the user wants to be included in the system watch. Based on the linked list 1002 in the correlation list 1000 of FIG. 10, the system monitoring parameter “ofrs disk space” 1304 and “free memory” 1306 are identified as correlated to the system monitoring parameter “active thread” 1302. The identified correlated system monitoring parameter 1304 and 1306 are then displayed on the user interface 1300. A user may select the system monitoring parameter “free memory” 1306 for generating the system watch.

FIG. 14 is an exemplary block diagram illustrating a system watch 1400 generated based on the primary system monitoring parameter “active thread” and the selected system monitoring parameter “free memory” 1306, according to an embodiment. Initially, the caution and danger threshold values for the system monitoring parameters “active thread” 1302 and “free memory” 1306 are obtained as {1, 5} and {1,5}, respectively, from the threshold matrix 1100 of FIG. 11. Next, a caution watch equation 1402 and a danger watch equation 1404 is generated based on the system monitoring parameters 1302 and 1306 and their corresponding caution threshold value and danger threshold value, respectively. The generated caution watch equation 1402 and danger watch equation 1404 together form the system watch 1400. In one embodiment, if the user selects both the system monitoring parameter “ofrs disk space” 1304 and the system monitoring parameter “free memory” 1306 in FIG. 13, then the system watch related equations 1202 and 1204 generated in FIG. 12 may directly be used to form the system watch 1400.

Some embodiments of the invention may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments of the invention may include remote procedure calls or web services being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hard-wired circuitry in place of, or in combination with machine readable software instructions.

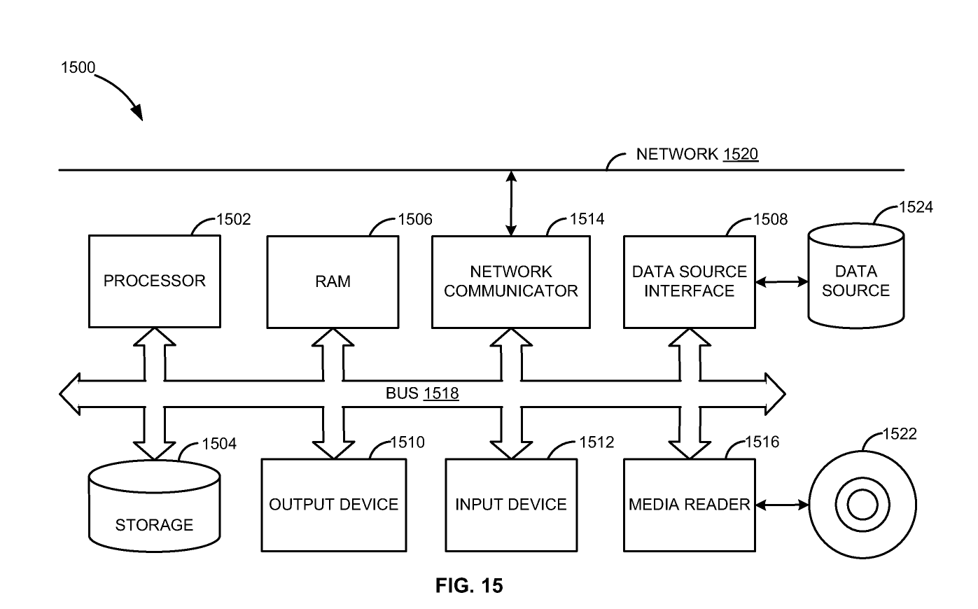

FIG. 15 is a block diagram of an exemplary computer system 1500. The computer system 1500 includes a processor 1502 that executes software instructions or code stored on a computer readable storage medium 1522 to perform the above-illustrated methods of the invention. The computer system 1500 includes a media reader 1516 to read the instructions from the computer readable storage medium 1522 and store the instructions in storage 1504 or in random access memory (RAM) 1506. The storage 1504 provides a large space for keeping static data where at least some instructions could be stored for later execution. The stored instructions may be further compiled to generate other representations of the instructions and dynamically stored in the RAM 1506. The processor 1502 reads instructions from the RAM 1506 and performs actions as instructed. According to one embodiment of the invention, the computer system 1500 further includes an output device 1510 (e.g., a display) to provide at least some of the results of the execution as output including, but not limited to, visual information to users and an input device 1512 to provide a user or another device with means for entering data and/or otherwise interact with the computer system 1500. Each of these output devices 1510 and input devices 1512 could be joined by one or more additional peripherals to further expand the capabilities of the computer system 1500. A network communicator 1514 may be provided to connect the computer system 1500 to a network 1520 and in turn to other devices connected to the network 1520 including other clients, servers, data stores, and interfaces, for instance. The modules of the computer system 1500 are interconnected via a bus 1518. Computer system 1500 includes a data source interface 1508 to access data source 1524. The data source 1524 can be accessed via one or more abstraction layers implemented in hardware or software. For example, the data source 1524 may be accessed by network 1520. In some embodiments the data source 1524 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments of the invention. One skilled in the relevant art will recognize, however that the invention can be practiced without one or more of the specific details or with other methods, components, techniques, etc. In other instances, well-known operations or structures are not shown or described in details to avoid obscuring aspects of the invention.

Although the processes illustrated and described herein include series of steps, it will be appreciated that the different embodiments of the present invention are not limited by the illustrated ordering of steps, as some steps may occur in different orders, some concurrently with other steps apart from that shown and described herein. In addition, not all illustrated steps may be required to implement a methodology in accordance with the present invention. Moreover, it will be appreciated that the processes may be implemented in association with the apparatus and systems illustrated and described herein as well as in association with other systems not illustrated.

The above descriptions and illustrations of embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. Rather, the scope of the invention is to be determined by the following claims, which are to be interpreted in accordance with established doctrines of claim construction.

1. A computer implemented method for monitoring a system, the method comprising:
receiving, by a processor of the computer, a request including a primary system monitoring parameter to generate a system watch for monitoring the system;
based on the received request, identifying, by the processor of the computer, one or more system monitoring parameters correlated to the primary system monitoring parameter from a system monitoring parameter database; and
generating, by the processor of the computer, the system watch based on the primary system monitoring parameter and at least one secondary system monitoring parameter from the identified one or more system monitoring parameters.

2. The computer implemented method according to claim 1, further comprising:
comparing, by the processor of the computer, the generated system watch with a plurality of system watches stored in the system monitoring parameter database;
based on the comparison, identifying, by the processor of the computer, a matching system watch from the plurality of system watches stored in the system monitoring parameter database;
retrieving, by the processor of the computer, a corrective action associated with the identified matching system watch from the system monitoring parameter database; and
assigning, by the processor of the computer, the retrieved corrective action to the generated system watch.

3. The computer implemented method according to claim 1, wherein generating the system watch includes:
displaying, on a user interface of the system, the identified one or more system monitoring parameters;
receiving a user selection of the at least one secondary system monitoring parameter from the displayed one or more system monitoring parameters; and
generating, by the processor of the computer, the system watch based on the primary system monitoring parameter and the received user selection.

4. The computer implemented method according to claim 1, wherein generating the system watch includes:
the processor of the computer, retrieving, from the system monitoring parameter database, maximum threshold values for the primary and the at least one secondary system monitoring parameter; and
generating, by the processor of the computer, a danger system watch equation for the system watch based on the maximum threshold values, and the primary and the at least one secondary system monitoring parameter.

5. The computer implemented method according to claim 1, wherein generating the system watch includes:
the processor of the computer, retrieving, from the system monitoring parameter database, minimum threshold values for the primary and the at least one secondary system monitoring parameter; and
generating, by the processor of the computer, a caution system watch equation for the system watch based on the minimum threshold values, and the primary and the at least one secondary system monitoring parameter.

6. The computer implemented method according to claim 1, further comprising:
based on a corrective action of one of the plurality of systems, receiving the request to create the system watch;
based on the received request, creating, by the processor of the computer, a copy of a system watch corresponding to the one of the plurality of systems; and
assigning, by the processor of the computer, the created system watch to the system.

7. The computer implemented method according to claim 1, wherein building the system monitoring parameter database including the one or more system monitoring parameters comprises:
receiving a system watch related input for a plurality of system watches; and
building, by the processor of the computer, the system monitoring parameter database based on the received system watch related input.

8. The computer implemented method according to claim 7, wherein building the system monitoring parameter database further comprises:
retrieving, by the processor of the computer, a plurality of system monitoring parameters from the received system watch related input;
computing, by the processor of the computer, a support value of the plurality of system monitoring parameters in the received user input;
comparing, by the processor of the computer, the determined support value of the plurality of system monitoring parameters with a predetermined minimum support value;
based on the comparison, identifying, by the processor of the computer, one or more system monitoring parameters from the plurality of system monitoring parameters; and
adding, by the processor of the computer, the identified one or more system monitoring parameters to a filtered set of system monitoring parameters.

9. The computer implemented method according to claim 8, wherein building the system monitoring parameter database further comprises:
computing, by the processor of the computer, a posterior probability of the filtered set of system monitoring parameters;
applying, by the processor of the computer, a genetic algorithm on the computed posterior probability;
based on the applied genetic algorithm, generating, by the processor of the computer, a correlation list including a plurality of system monitoring parameters, from the identified one or more system monitoring parameters, correlated to each other; and
storing, in the system monitoring parameter database, the generated correlation list.

10. The computer implemented method according to claim 9, wherein building the system monitoring parameter database further comprises:
retrieving, from the user input, threshold values for the filtered set of system monitoring parameters;
storing the retrieved threshold values in the system monitoring parameter database;
based on the retrieved threshold values and the correlation list, generating, by the processor of the computer, one or more system watch equations; and
storing the system watch equations in the system monitoring parameter database.

11. An article of manufacture including a computer readable storage medium to tangibly store instructions, which when executed by a computer, cause the computer to:
receive a request including a primary system monitoring parameter to generate a system watch for monitoring a system;
based on the received request, identify, one or more system monitoring parameters correlated to the primary system monitoring parameter from a system monitoring parameter database; and
generate the system watch based on the primary system monitoring parameter and at least one secondary system monitoring parameter from the identified one or more system monitoring parameters.

12. The article of manufacture according to claim 11, further comprising instructions which when executed by the computer further causes the computer to:
receive a system watch related input for a plurality of system watches; and
build the system monitoring parameter database based on the received system watch related input.

13. The article of manufacture according to claim 12, further comprising instructions which when executed by the computer further causes the computer to:
retrieve a plurality of system monitoring parameters from the received system watch related input;
compute a support value of the plurality of system monitoring parameters in the received user input;
compare the determined support value of the plurality of system monitoring parameters with a predetermined minimum support value;
based on the comparison, identify one or more system monitoring parameters from the plurality of system monitoring parameters; and
add the identified one or more system monitoring parameters to a filtered set of system monitoring parameters.

14. The article of manufacture according to claim 13, further comprising instructions which when executed by the computer further causes the computer to:
compute a posterior probability of the filtered set of system monitoring parameters;
apply a genetic algorithm on the computed posterior probability;
based on the applied genetic algorithm, generate a correlation list including a plurality of system monitoring parameters, from the identified one or more system monitoring parameters, correlated to each other; and
store, in the system monitoring parameter database, the generated correlation list.

15. The article of manufacture according to claim 14, further comprising instructions which when executed by the computer further causes the computer to:
retrieve, from the user input, threshold values for the filtered set of system monitoring parameters;
based on the retrieved threshold values and the correlation list, generate one or more system watch equations; and
store the generated one or more system watch equations in the system monitoring parameter database.

16. A computer system for monitoring a system, the computer system comprising:
a memory to store a program code; and
a processor communicatively coupled to the memory, the processor configured to execute the program code to:
receive a request including a primary system monitoring parameter to generate a system watch for monitoring the system;
based on the received request, identify, one or more system monitoring parameters correlated to the primary system monitoring parameter from a system monitoring parameter database; and
generate the system watch based on the primary system monitoring parameter and at least one secondary system monitoring parameter from the identified one or more system monitoring parameters.

17. The system of claim 16, wherein the processor further executes the program code to:
receive a system watch related input for a plurality of system watches; and
build the system monitoring parameter database based on the received system watch related input.

18. The system of claim 17, wherein the processor further executes the program code to:
retrieve a plurality of system monitoring parameters from the received system watch related input;
compute a support value of the plurality of system monitoring parameters in the received user input;
compare the determined support value of the plurality of system monitoring parameters with a predetermined minimum support value;
based on the comparison, identify one or more system monitoring parameters from the plurality of system monitoring parameters; and
add the identified one or more system monitoring parameters to a filtered set of system monitoring parameters.

19. The system of claim 18, wherein the processor further executes the program code to:
compute a posterior probability of the filtered set of system monitoring parameters;
apply a genetic algorithm on the computed posterior probability;
based on the applied genetic algorithm, generate a correlation list including a plurality of system monitoring parameters, from the identified one or more system monitoring parameters, correlated to each other; and
store, in the system monitoring parameter database, the generated correlation list.

20. The system of claim 19, wherein the processor further executes the program code to:
retrieve, from the user input, threshold values for the filtered set of system monitoring parameters;
based on the retrieved threshold values and the correlation list, generate one or more system watch equations; and
store the generated one or more system watch equations in the system monitoring parameter database.
